(19) United States
(12) Patent Application Publication
(10) Pub. No.: US 2022/0362791 A1
(43) Pub. Date: Nov. 17, 2022

(54) Portable Pressurized Dual Spray Hydration Reservoir

(71) Applicant: Outdoor Culture, Inc., Vista, CA (US)

(72) Inventor: Christopher Jackson Crawford, Carlsbad, CA (US)

(21) Appl. No.: 17/663,194

(22) Filed: May 12, 2022

Related U.S. Application Data
(60) Provisional application No. 63/187,921, filed on May 12, 2021.
(60) Provisional application No. 63/202,217, filed on Jun. 1, 2021.

(51) Int. Cl. B05B 9/08; B05B 1/16; B65D 51/24; B65D 43/02; A45F 3/18

(52) U.S. Cl. CPC B05B 9/0816; B05B 1/1609; B65D 51/242; B65D 43/0231; A45F 3/18

(57) ABSTRACT

A portable pressurized dual spray hydration reservoir has a container that is cylindrically shaped in a manner similar to many common reusable water bottles. Attached to the lid is a plunger pump assembly with a pump handle that can be used to pump air into the container. The introduction of air via the pump pressurizes the container, causing the liquid inside to be dispersed through a nozzle when a release valve is engaged. Each of two release valves on the lid is associated with a corresponding nozzle. The first release valve disperses liquid through the first nozzle as a stream, and the second release valve disperses liquid through the second nozzle as a spray.

### RELATED APPLICATION

This application claims the benefit of priority to U.S. Provisional Patent Application Ser. No. 63/187,921 for a “PORTABLE PRESSURIZED DUAL SPRAY HYDRATION RESERVOIR,” filed May 12, 2021, and currently co-pending, and U.S. Provisional Patent Application Ser. No. 63/202,217 for a “Portable Pressurized Dual Spray Hydration Reservoir,” filed Jun. 1, 2021, and currently co-pending, which are incorporated herein by reference.

### FIELD OF THE INVENTION

The present invention relates generally to portable water reservoirs, such as sports drinking bottles, used to keep athletes cool and hydrated. The present invention, more particularly, is useful for a portable hydration source that can dispense a single stream of water, such as for drinking, and a distributed spray of water, such as for body spraying and cooling.

### BACKGROUND OF THE INVENTION

Water needs to be dispensed in various manners for different tasks. Typically, a single tool is used for a single manner or set of closely related manners of dispensing water. Portable water containers in particular are virtually always oriented around a single mode of dispensing water.

Participants in sports or outdoor recreation often need to carry water intended for multiple uses, such as drinking, body spraying, and cooling. Currently, they are forced to rely on inefficient methods, such as using a standard water bottle for both drinking and watering the face despite the lack of ability to “spray” the water, or to forego some desired uses of water.

In view of the above, it would be advantageous to provide an apparatus to dispense water in multiple manners. It would be further advantageous to provide a portable water reservoir with a dispensing apparatus suitable for multiple methods of dispensing.

### SUMMARY OF THE INVENTION

Disclosed is a portable pressurized dual spray hydration reservoir. The hydration reservoir has a container that, in a preferred embodiment, is cylindrically shaped in a manner similar to many common reusable water bottles. Attached to the lid is a plunger pump assembly with a pump handle that can be used to pump air into the container. The introduction of air via the pump pressurizes the container, causing the liquid inside to be dispersed through a nozzle when a release valve is engaged.

A preferred embodiment of the portable pressurized dual spray hydration reservoir has two nozzles, each associated with its own release valve. One of the nozzles has a single aperture and dispenses water as a stream. The other nozzle has an array of apertures to dispense water as a spray. In a preferred embodiments, the nozzles are removable for cleaning and replaceable, and in some preferred embodiments, interchangeable with other nozzles.

A carrying handle is either attached to or integral to the lid in preferred embodiments, providing a simple manner of carrying the reservoir.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is an upper perspective view of a preferred embodiment of a portable pressurized dual spray hydration reservoir;

FIG. 2 is a perspective view of the portable pressurized dual spray hydration reservoir showing the pump handle in a raised position;

FIG. 3 is a perspective view of the portable pressurized dual spray hydration reservoir showing the pump handle in a raised and rotated position;

FIG. 4 is an upper perspective view of the plunger pump assembly of the portable pressurized dual spray hydration reservoir;

FIG. 5 is a lower perspective view of the plunger pump assembly of the portable pressurized dual spray hydration reservoir;

FIG. 6 is a side view of the plunger pump assembly of the portable pressurized dual spray hydration reservoir;

FIG. 7 is a front view of the plunger pump assembly of the portable pressurized dual spray hydration reservoir;

FIG. 8 is a cross-sectional side view of the plunger pump assembly of the portable pressurized dual spray hydration reservoir;

FIG. 9 is a cross-sectional front view of the plunger pump assembly of the portable pressurized dual spray hydration reservoir;

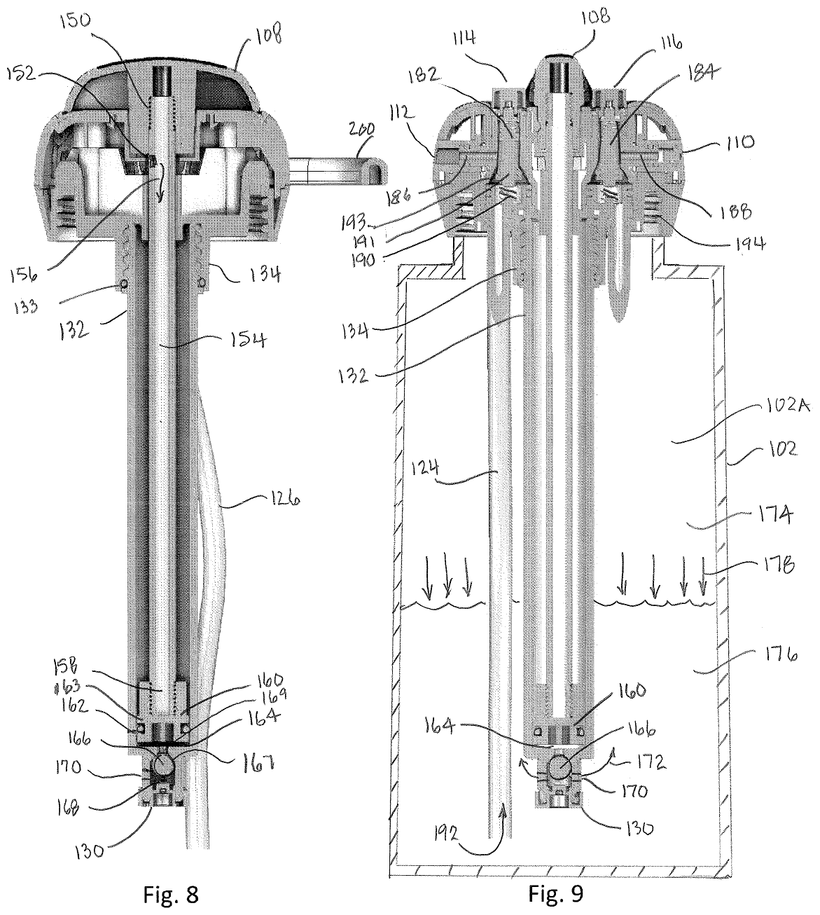

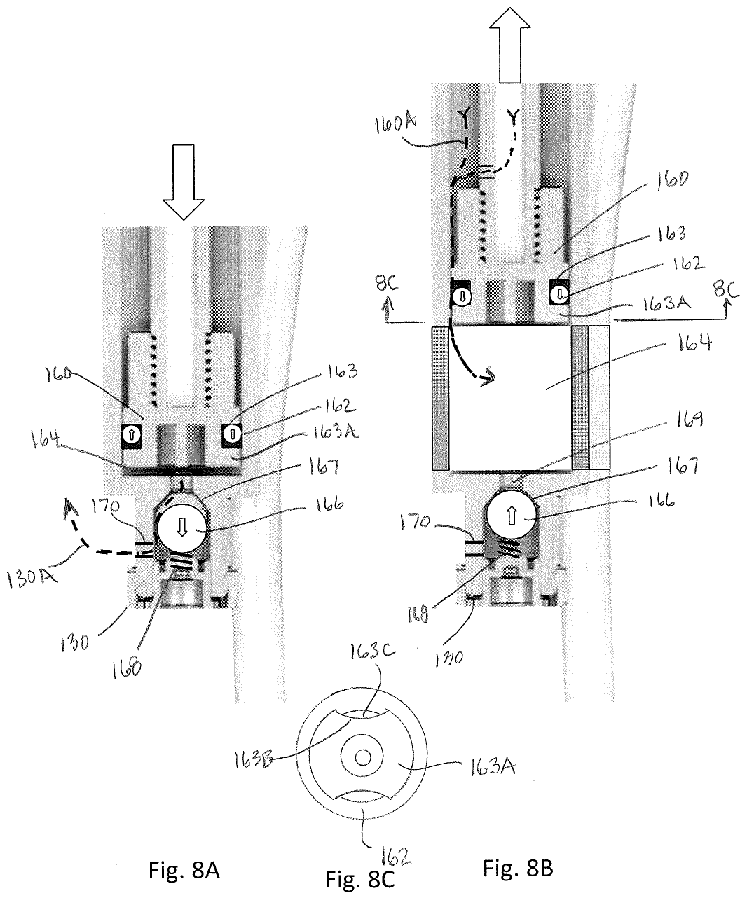

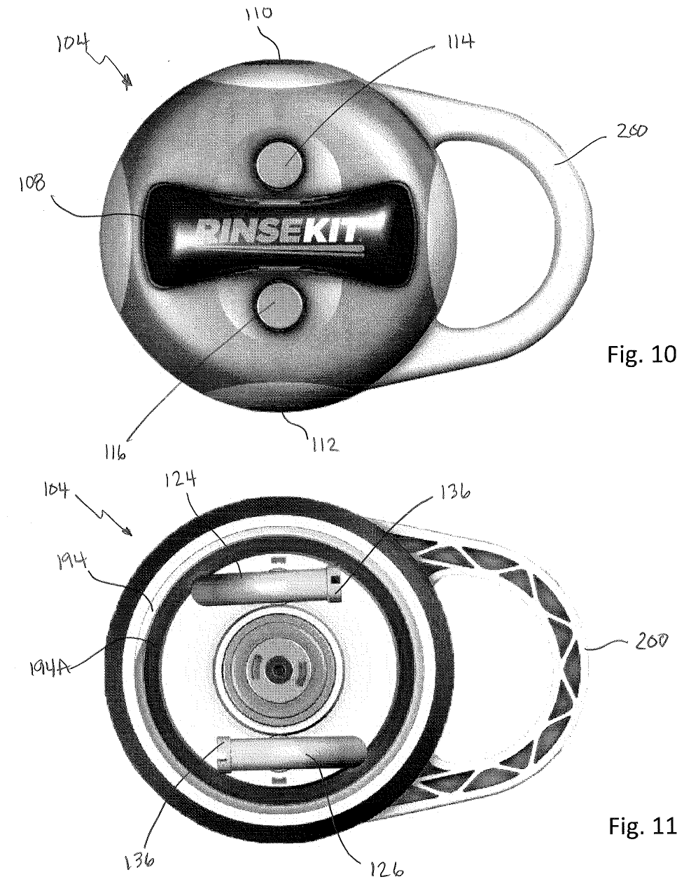

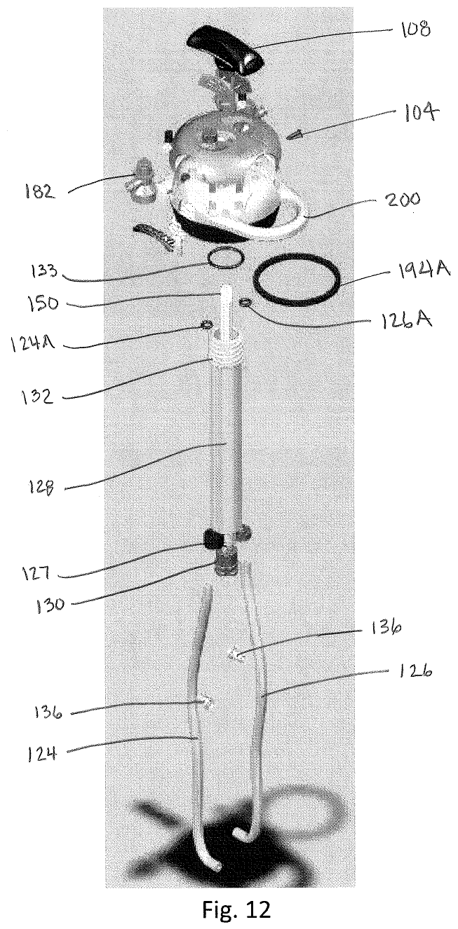

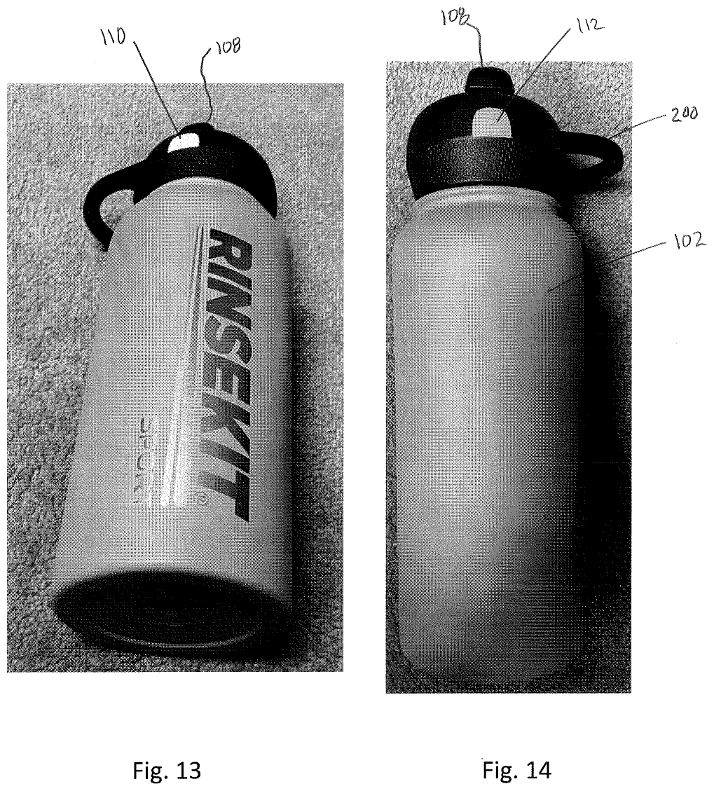

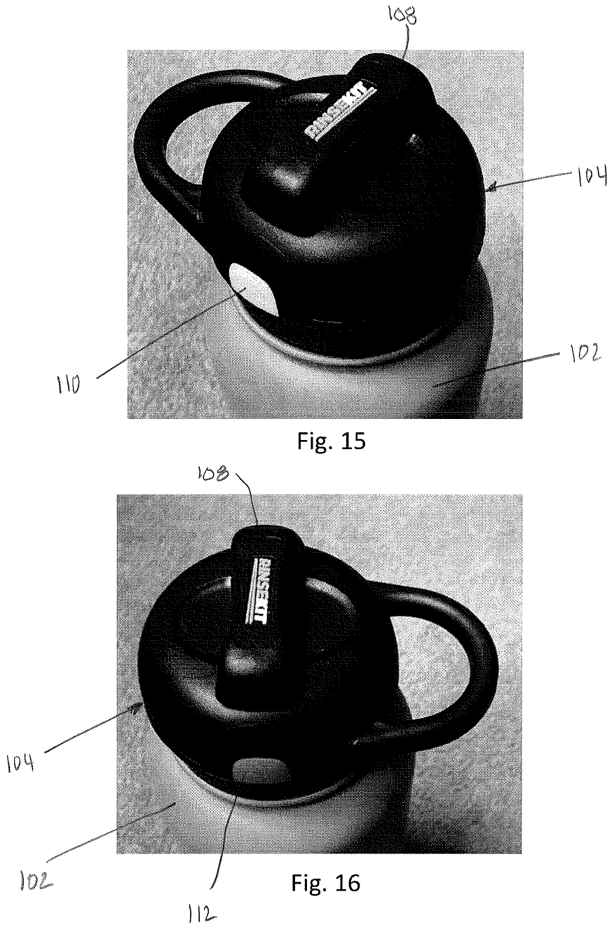

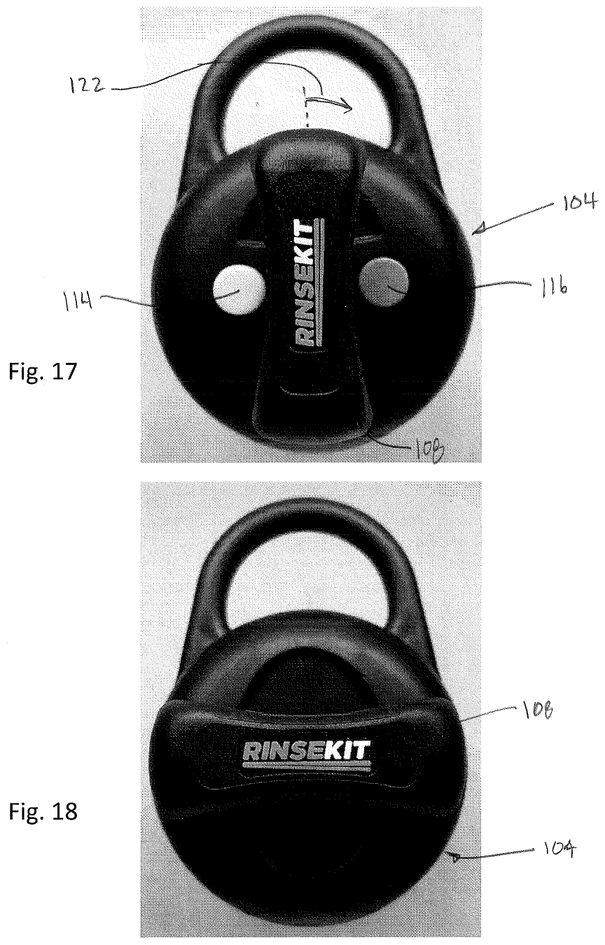

FIG. 8A is a diagram of pump action as the pump handle is pushed downwards;

FIG. 8B is a diagram of pump action as the pump handle is drawn upwards;

FIG. 8C is a cross-sectional view of an upper air inlet valve of the pump assembly of the portable dual spray hydration reservoir, as taken along line 8C-8C of FIG. 8B;

FIG. 10 is an upper view of the pump assembly of the portable pressurized dual spray hydration reservoir;

FIG. 11 is a lower view of the pump assembly of the portable pressurized dual spray hydration reservoir;

FIG. 12 is an exploded view of the pump assembly of the portable pressurized dual spray hydration reservoir;

FIG. 13 is a lower perspective view of the portable pressurized dual spray hydration reservoir;

FIG. 14 is another lower perspective view of the portable pressurized dual spray hydration reservoir;

FIG. 15 is a partial upper perspective view of the portable pressurized dual spray hydration reservoir;

FIG. 16 is another partial upper perspective view of the portable pressurized dual spray hydration reservoir;

FIG. 17 is a top view of the portable pressurized dual spray hydration reservoir showing the pump handle in a rotated configuration uncovering the release valves;

FIG. 18 is a top view of the portable pressurized dual spray hydration reservoir showing the pump handle in an unrotated configuration in which the release valves are covered;

FIG. 19 is a close-up view of a spray nozzle of the portable pressurized dual spray hydration reservoir; and

FIG. 20 is a close-up view of another spray nozzle of the portable pressurized dual spray hydration reservoir.

### DETAILED DESCRIPTION

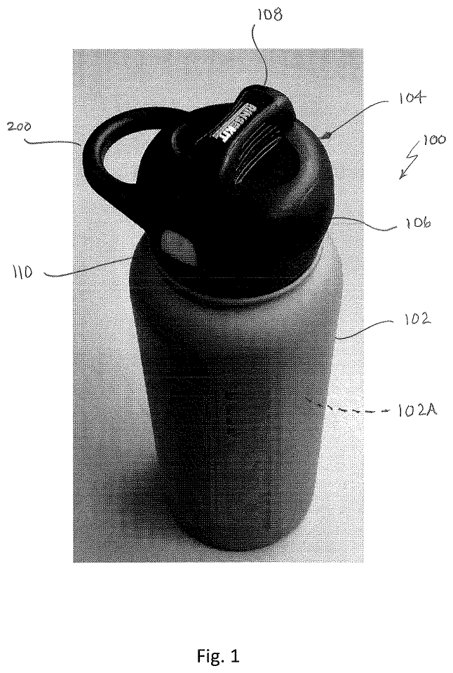

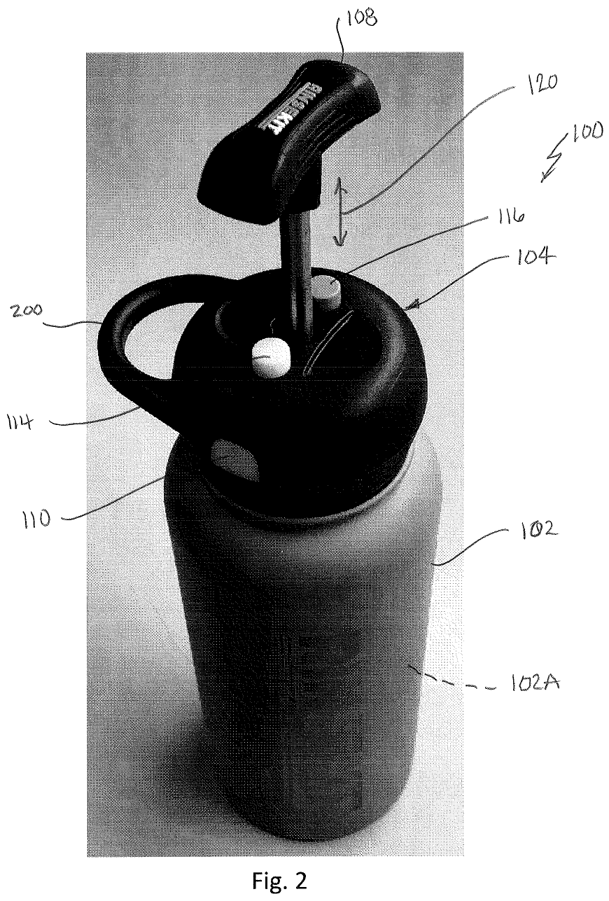

Referring initially to FIG. 1, a perspective view of the portable pressurized dual spray hydration reservoir is shown and generally designated 100. Reservoir 100 has a cylindrically shaped container 102 formed as many common water bottles with a threaded opening and defining an interior chamber 102A for liquid storage, such as water. The container 102 is sealed with a plunger pump assembly 104 having a container lid 106 threadably engageable to the threaded opening of the container 102 and equipped with a pump handle 108 in combination with a pump for injecting air into the interior chamber 102A to pressurize the chamber, and a pair of opposing nozzles 110, 112 for dispersion of the liquid within the chamber when a release valve (shown in FIG. 2) is activated.

FIG. 2 is a perspective view of the portable pressurized dual spray hydration reservoir 100 of the present invention showing the pump handle 108 and pump assembly 104 with the pump handle 108 in the raised position revealing a pair of release valves 114, 116 corresponding to nozzles 110, 112, such as a spray nozzle and a stream nozzle. The pump handle 108 may be raised and lowered in direction 120 through the plunger pump assembly 104 to inject air into the interior chamber 102A to increase the pressure within the chamber. Once pressurized greater than the atmospheric ambient pressure, activation of either or both release valves 114, 116 allows water to pass from the interior chamber 102A through the spray and stream nozzles 110, 112.

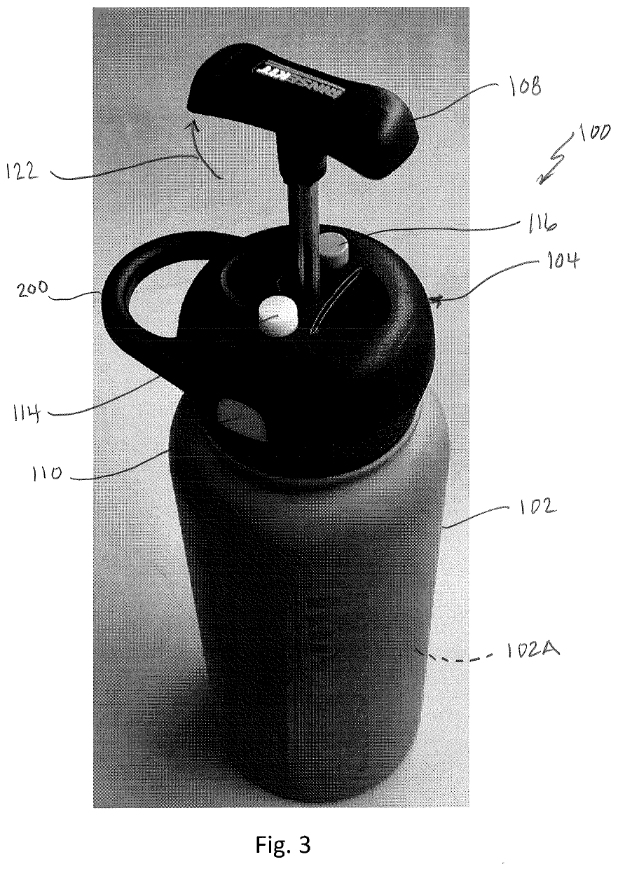

FIG. 3 is a perspective view of the portable pressurized dual spray hydration reservoir 100 of the present invention showing the pump handle 108 in a 90 degree rotated position from that of FIG. 2. In this configuration, the pump handle 108 may be positioned against the plunger pump assembly 104 to allow access to the release valves 114, 116 for use. In the other configuration wherein the pump handle 108 is rotated in direction 122 and positioned against the plunger pump assembly 104 such that the pump handle 108 covers the release valves 114, 116, the unit is configured for storage without concern for the inadvertent activation of the release valves 114, 116, such as when the device is stored in a backpack or other travel situation.

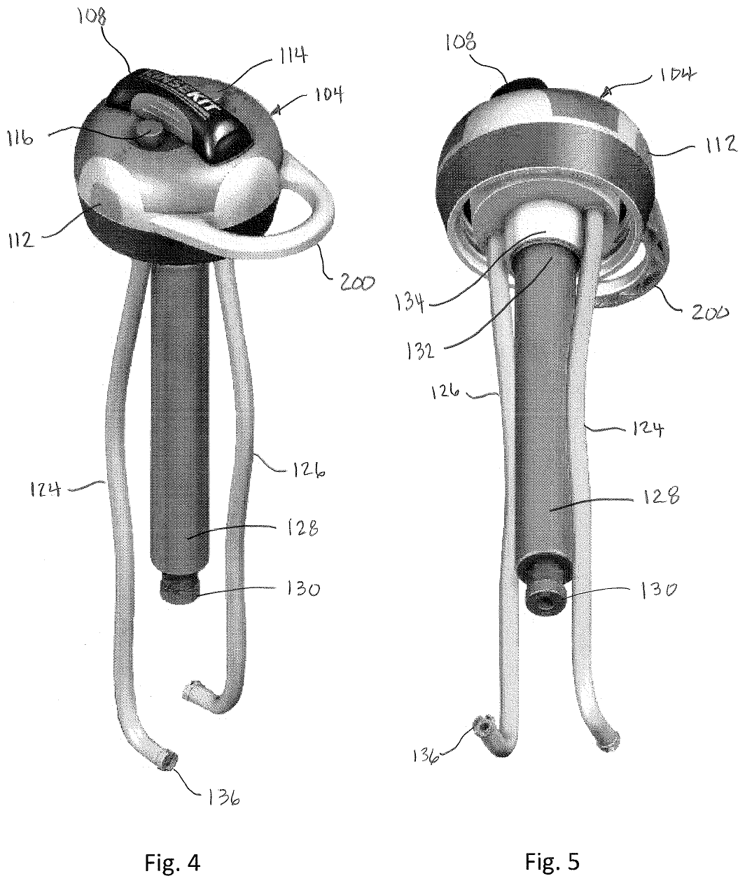

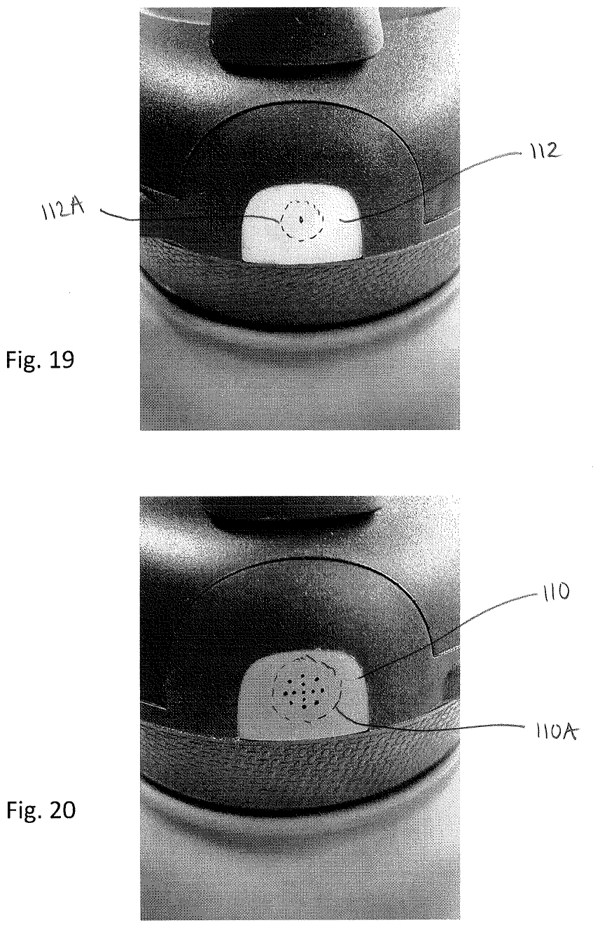

FIGS. 4 and 5 are upper and lower perspective views of the plunger pump assembly 104 of the portable pressurized dual spray hydration reservoir 100 of the present invention showing the two water feed tubes 124, 126 and the pump tube 128 having a pump chamber 164 (shown in FIGS. 8 and 9) and lower air outlet valve 130. As shown the pump handle 108 is in the down position, and as will be discussed in greater detail below, as the pump handle is raised in direction 120, the lower air outlet valve 130 on the lower portion of the pump tube 128 closes, and air flows into the pump chamber 164 in pump tube 128 as provided through an upper inlet air valve 160 on the distal end 158 of pump handle 108, and as the pump handle 108 is lowered, the upper inlet air valve 160 (not shown this Figure) closes and the air passes under pressure through the lower air outlet valve 130 and into the interior chamber 102A. Once desired pressure is achieved, the pump handle 108 is returned to its down position, and the water within the interior chamber 102A can be dispensed by pressing one of the release valves 114, 116 allowing the pressurized water to pass from the interior chamber 102A, through the release valve 114, 116, and out the nozzle 110, 112.

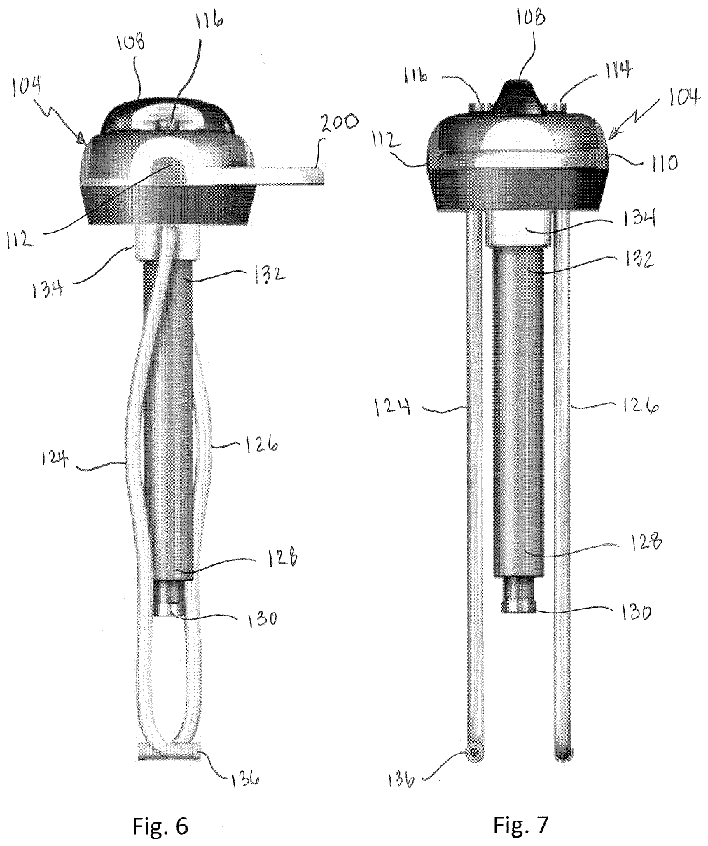

FIGS. 6 and 7 are side views of the plunger pump assembly 104 of the portable pressurized dual spray hydration reservoir 100 of the present invention showing the placement of the water feed tubes 124, 126, pump tube 128 and release valves 114, 116. From these two Figures, it can be seen that each feed tube 124, 126 is equipped with a weighted flange 136 attached at the distal end of each tube to ensure that, regardless of the orientation of the device 100, the open ends of the feed tubes 124, 126 are submerged in the water within the interior chamber 102A.

FIGS. 8 and 9 are cross-sectional views of the plunger pump assembly 104 of the portable pressurized dual spray hydration reservoir 100 of the present invention showing the tubular orientation of the pump assembly 104 and pump handle 108. As can be appreciated from these two Figures, when the pump handle 108 begins in the down position, as the pump handle 108 is raised, the lower air outlet valve 130 on the lower portion of the pump chamber 164 closes by spring 168 pushing sealing ball 166 upwards into seat 167 to prevent the contents from chamber 102A from entering the pump assembly through aperture 170. As pump handle 108 is raised, a vacuum is created in pump chamber 164 and air flows into pump tube 128 through inlet 152 in direction 156 and into pump chamber 164 via an upper inlet air valve 160 because sealing ring 162 unseats from ring seat 163 to allow air to pass through to pump chamber 164. Then, as the pump handle 108 is lowered, the upper inlet air valve 160 closes by sealing ring 162 seating firmly to seat 163 and the air from within pump chamber 164 passes through the lower air outlet valve 130 by the air pressure overcoming the spring 168 force on sealing ball 167 such that air 174 passes through aperture 169 past sealing ball 167, through vents 170 and in direction 172 into the interior chamber 102A. This process is repeated to increase the pressure 178 within interior chamber 102A. Once desired pressure 178 is achieved, the pump handle 108 is returned to its down position, and the water 176 within the interior chamber 102A can be dispensed by pressing one of the release valves 114, 116 allowing the pressurized water 176 to pass 192 from the interior chamber 102A, through the release valves 114, 116, and out the nozzles 110, 112.

From FIGS. 8A and 8B, the cooperation of the upper inlet air valve 160 and lower air outlet valve 130 are shown. As pump handle is drawn upwards in FIG. 8B, air bypasses upper inlet air valve 160 and enters pump chamber 164 because sealing ring 162 is drawn away from seat 163 to create a gap as shown by dashed lines depicting air flow 160A. In order to create the vacuum necessary within pump chamber 164, spring 168 in lower air outlet valve 130 pushes sealing ball 166 against seat 167 thus preventing air or liquid from entering pump chamber 164.

Once the pump handle has been fully extended upwards, the pump handle is then pushed downwards as shown in FIG. 8A. As pump handle 108 is pushed downward, the pressure created in pump chamber 164 pushes sealing ring 162 against seat 163 thus closing the upper inlet air valve 160. As pump handle 108 is pushed downward, the pressure in pump chamber 164 increases to overcome the spring force from spring 168 thus causing the sealing ball 166 to move downward opening the lower air outlet valve 130 and air leaves the pump chamber by dashed lines depicting air flow 130A.

FIG. 8C shows a cross-sectional view an exemplary upper air inlet valve 160 as taken along line 8C-8C of FIG. 8B, in which the lower seat 163A is shaped to allow air to pass when the upper air inlet valve 160 is drawn upwards. In this configuration, portions 163B of the lower seat 163A are removed that result in the sealing ring 162 to deform from the walls of pump tube 128 and create a gap 163C allowing for air to pass between sealing ring 162 and seat 163 and into pump chamber 164.

Referring to FIG. 9, the placement and cooperation of the release valves 114, 116 are shown. Specifically, valve assembly 182 includes a plunger 191 that is spring biased upwards by spring 190 to contact plunger seat 193 to seal the valve. When release valve 114 is pressed, it activates valve assembly 182 which overcomes the spring bias of spring 190 such that plunger 191 separates from plunger seat 193 to provide a fluid pathway for water 176 entering flow tube 124 in direction 192 to flow upwards, past the plunger 191, and out bore 186 through nozzle 112. It can be appreciated, that the higher the pressure 178 in chamber 102A, the more force water 176 will exit nozzle 112. Valve assembly 184 is responsive to release valve 116 in a similar fashion.

FIGS. 10 and 11 are upper and lower views of the plunger pump assembly 104 of the portable pressurized dual spray hydration reservoir 100 of the present invention showing the plunger pump assembly 104 with the pump handle 108 in the lower position revealing the pair of release valves 114, 116 corresponding to a stream nozzle 110 and a spray nozzle 112. As discussed, the pump handle 108 may be raised and lowered through the plunger pump assembly 104 to inject air 174 into the interior chamber 102A to increase the pressure 178 within the chamber. Once pressurized greater than the atmospheric ambient pressure, activation of either or both release valves 114, 116 allows water to pass from the interior chamber 102A through the stream and spray nozzles 110, 112.

The lower view of FIG. 11 also shows the placement of the weighted flanges 136 on the ends of tubes 124, 126 and also shows threaded portion 194 of the plunger pump assembly 104 that corresponds with the threads at the opening of the reservoir 102. Also, a sealing ring 195 is shown to seal the mating surface between the reservoir 102 and the plunger pump assembly 104.

FIG. 12 is an exploded view of the plunger pump assembly 104 of the portable pressurized dual spray hydration reservoir 100 of the present invention showing the various seals and components of the system. For instance, the pump handle 108 and pump shaft 150 that supports the upper air intake valve 160 are shown, and cooperate through the pump tube 128 with the lower air outlet valve 130 to pressurize through longitudinal motion 120 the interior chamber 102A. Also shown are the two release valve assemblies 182 that are operated by release valves 114, 116, which in a preferred embodiment, are an on-off style valve, allowing the first button push to open the valve, and the second button push to close the valve. This on-off valve, however, can be replaced with a momentary on-off valve that would only allow the passage of pressurized water when the valve button is depressed, returning to its closed position once no longer depressed. In a preferred embodiment, one release valve may be on-off style, while the other is a push-on, push-off type.

FIGS. 13 and 14 are lower perspective and side views of the portable pressurized dual spray hydration reservoir 100 of the present invention showing the fluid reservoir 102 shape and style, and the threadable engagement of the pump assembly thereto. It can be appreciated from these two figures, however, than any shaped container could be used without departing from the present invention. Also shown are the nozzles 110, 112 on each side of the device 100, and also a handle 200 for carrying the portable pressurized dual spray hydration reservoir 100.

FIGS. 15 and 16 are upper perspective views of the portable pressurized dual spray hydration reservoir 100 of the present invention showing the pump assembly 104 as attached to a container 102, and showing the two separate types of spray nozzles 114, 116. Also from these two Figures, the release valves are covered with handle 108 thereby preventing the inadvertent activation of the valves 114, 116 during storage or transport.

FIGS. 17 and 18 are top plan views of the portable pressurized dual spray hydration reservoir 100 of the present invention showing the pump handle 108 in position to allow access to the release valves 114, 116 for use, and also showing the pump handle 108 rotated 90 degrees 122 to cover the release valves 114, 116 for storage or transport. Also shown here are the different color release valves 114, 116 that allow a user to easily identify which valve to press to receive which spray or stream from nozzles 110, 112 (not shown here). In a preferred embodiment, pressing the blue release valve 116 will activate the spray nozzle 110A, while pressing the grey release valve 114 will activate the steam nozzle 112A. Of course, other colors, textures, or shapes may be used to easily distinguish the two release valves so that they can be activated by feel and without looking such as for extreme athletes during extreme events, such as competitive road bicycling, intense motor sports, or the like.

FIGS. 19 and 20 are close-up views of the two spray nozzles of the portable pressurized dual spray hydration reservoir 100 of the present invention. In a preferred embodiment, these nozzles are different, and in the current embodiment, a first nozzle 112 has a single aperture 112A designed to direct the liquid leaving the pressurized chamber in a single stream. A second nozzle 110, in the current embodiment, has an array of many apertures 110A to direct the liquid leaving the pressurized chamber into a spray. In a preferred embodiment, first nozzle 112 and second nozzle 110 are located opposite each other, both on the edge or perimeter of container lid 106; in other words, they are both on the edge of lid 106 and located one-hundred eighty (180) degrees apart.

It is fully contemplated that any variety of nozzles may be used in the present invention, and can include larger or smaller diameter apertures, various number of apertures, or a combination of various sized apertures in a single nozzle to provide for a unique spray pattern. It is also fully contemplated here that the nozzles of the present invention are interchangeable. Specifically, nozzles may be replaced, removed and cleaned, or changed depending on the intended use of the present invention.

While there have been shown what are presently considered to be preferred embodiments of the present invention, it will be apparent to those skilled in the art that various changes and modifications can be made herein without departing from the scope and spirit of the invention.

What is claimed is:

1. A hydration reservoir, comprising:
a cylindrically shaped container having an opening and defining an interior chamber for liquid storage;
a plunger pump assembly;
a container lid having a pump handle, the container lid attached to the plunger pump assembly and removably attached to the cylindrically shaped container;
a plurality of nozzles on the container lid; and
a plurality of release valves, each release valve corresponding to a nozzle of the plurality of nozzles,
wherein the pump handle is engageable to cause the pump to inject air into the interior chamber, thereby pressurizing the interior chamber, and
wherein each release valve of the plurality of release valves is engageable to dispense water from the pressurized interior chamber through the corresponding nozzle.

2. The hydration reservoir of claim 1, wherein the plurality of nozzles comprises a first nozzle configured to dispense liquid in a stream and a second nozzle configured to spray liquid.

3. The hydration reservoir of claim 2, wherein the release valve corresponding to the first nozzle comprises a first texture and the release valve corresponding to the second nozzle comprises a second texture distinct from the first texture.

4. The hydration reservoir of claim 2, wherein the first nozzle is located on a perimeter of the container lid, and the second nozzle is located opposite the first nozzle on the perimeter of the container lid.

5. The hydration reservoir of claim 4, wherein the pump handle is rotatable from a first configuration in which the pump handle covers the plurality of release valves, into a second configuration in which the plurality of release valves is uncovered.

6. The hydration reservoir of claim 5, wherein the pump handle is placed in the second configuration by rotating the pump handle ninety degrees.

7. The hydration reservoir of claim 4, wherein the first nozzle and the second nozzle are removable and replaceable.

8. The hydration reservoir of claim 7, wherein the first nozzle and the second nozzle are interchangeable with additional nozzles.

9. The hydration reservoir of claim 4, further comprising a carrying handle formed into the container lid.

10. A hydration reservoir, comprising:
a cylindrically shaped container having a threaded opening and defining an interior chamber for liquid storage;
a threaded container lid having a pump handle and threadably engageable to the threaded opening of the cylindrically shaped container;
a plunger pump assembly attached to the container lid such that it is located in the interior chamber when the container lid is engaged to the cylindrically shaped container;
a first nozzle on a perimeter of the container lid and associated with a first release valve on the container lid; and
a second nozzle on the perimeter of the container lid and associated with a second release valve on the container lid,
wherein the pump handle is engageable to cause the pump to inject air into the interior chamber, thereby pressurizing the interior chamber, and
wherein the first release valve is engageable to dispense liquid from the pressurized interior chamber through the first nozzle, and the second release valve is engageable to dispense liquid from the pressurized interior chamber through the second nozzle.

11. The hydration reservoir of claim 10, wherein the second nozzle is located opposite the first nozzle on the perimeter of the container lid.

12. The hydration reservoir of claim 10, wherein the first nozzle is configured to dispense liquid in a stream and the second nozzle is configured to dispense liquid by spraying.

13. The hydration reservoir of claim 10, wherein the first release valve comprises a first texture and the second release valve comprises a second texture distinct from the first texture.

14. The hydration reservoir of claim 10, wherein the first release valve comprises a first color and the second release valve comprises a second color distinct from the first color.

15. The hydration reservoir of claim 10, wherein the first nozzle and the second nozzle are removable and replaceable.

16. The hydration reservoir of claim 15, wherein the first nozzle and the second nozzle are interchangeable with additional nozzles.

17. The hydration reservoir of claim 10, wherein the pump handle is rotatable from a first configuration in which the pump handle covers the first release valve and the second release valve, into a second configuration in which the first release valve and the second release valve are uncovered.

18. The hydration reservoir of claim 17, wherein the pump handle is alternated between the first configuration and the second configuration by rotating the pump handle ninety degrees.

19. A hydration reservoir, consisting essentially of:
a cylindrically shaped container having a threaded opening and defining an interior chamber for liquid storage;
a threaded container lid having a carrying handle and a pump handle, the threaded container lid threadably engageable to the threaded opening of the cylindrically shaped container;
a plunger pump assembly attached to the container lid such that it is located in the interior chamber when the container lid is engaged to the cylindrically shaped container;
a first nozzle on a perimeter of the container lid and associated with a first release valve on the container lid; and
a second nozzle on the perimeter of the container lid and associated with a second release valve on the container lid,
wherein the pump handle is engageable to cause the pump to inject air into the interior chamber, thereby pressurizing the interior chamber, and
wherein the first release valve is engageable to dispense liquid in a stream from the pressurized interior chamber through the first nozzle, and the second release valve is engageable to dispense liquid in a spray from the pressurized interior chamber through the second nozzle.

20. The hydration reservoir of claim 19, wherein the pump handle is rotatable from a first configuration in which the pump handle covers the first release valve and the second release valve, into a second configuration in which the first release valve and the second release valve are uncovered.
